(19) United States
(12) Patent Application Publication
(10) Pub. No.: US 2026/0148159 A1
(43) Pub. Date: May 28, 2026

(54) DYNAMIC MULTI-OBJECTIVE ASSIGNMENT OPTIMIZATION

(71) Applicant: DISNEY ENTERPRISES, INC., Burbank, CA (US)

(72) Inventors: Frederick C. ZAHRN, Orlando, FL (US); Ramin FAKHIMI, Orlando, FL (US); Anthony T. CHAU, Orlando, FL (US); Elaine DeMeyer MULHALL, Orlando, FL (US); Julie M. WELLONS, Orlando, FL (US); Rebecca MCDONOUGH, Middleton, FL (US); Haining YU, Windermere, FL (US); Hai D. CHU, Orlando, FL (US); Stefano TRACÀ, Orlando, FL (US); Aaron Robert WONG, Burbank, CA (US); Ludwig C. KUZNIA, Lakeland, FL (US); Ronald S. KOZAKOWSKI, Winter Garden, FL (US); Tianke FENG, Burbank, CA (US); Scott LEVINE, Windermere, FL (US); Cody MELVIN, Davenport, FL (US); Jieling XU, Winter Garden, FL (US); Jennifer G. WALSTON, Orlando, FL (US); Wei YUAN, Orlando, FL (US); Brian H. MCAULAY, Celebration, FL (US)

(21) Appl. No.: 18/959,139

(22) Filed: Nov. 25, 2024

(51) Int. Cl. G06Q 10/0631; G06N 20/00; G06Q 10/02

(52) U.S. Cl. CPC G06Q 10/06315; G06N 20/00; G06Q 10/02

(57) ABSTRACT

One embodiment of the present invention sets forth a technique for processing requests. The technique includes retrieving, from one or more data sources, a plurality of reservations and a plurality of available rooms associated with a first time frame, and generating a set of valid assignments of one or more available rooms to each reservation. The technique also includes generating, based on (i) the sets of valid assignments for the plurality of reservations and (ii) a plurality of matching objectives, a plurality of initial assignments of at least a portion of the available rooms to the plurality of reservations. The technique further includes performing a check-in process for a first reservation based on the plurality of initial assignments.

### BACKGROUND

### Field of the Various Embodiments

Embodiments of the present disclosure relate generally to techniques for searching, retrieving, and processing data and, more specifically, to dynamic multi-objective assignment optimization.

### Description of the Related Art

Computer-based search, retrieval, and data-processing techniques have been used to streamline various technological use cases and applications. For example, a search tool may be incorporated into an online platform for processing and managing requests related to room reservations at a hotel, resort, and/or another type of property. The search tool may allow users to search for new and/or preexisting reservations, match reservation dates and group sizes to available rooms, generate new room assignments from the matches, and/or undo or modify existing room assignments. The search tool may also allow the users to sort and/or filter the reservations and/or rooms by attributes such as room number, room type, room class, building floor, check-in and/or check-out date, rate of occupancy, status (e.g., dirty, clean, inspected, out of service, etc.), room features, and/or smoking or non-smoking rooms.

However, existing online platforms and/or search tools are unable to dynamically adapt to new reservations, changes to existing reservations, changes in room availability over time, and/or guest requirements and/or preferences that fall outside of pre-specified attributes. Instead, these solutions typically require a manual “rework” of room assignments to account for the changes, which consumes additional time and resources beyond those involved in making the initial room assignments.

Existing online platforms and/or search tools are further unable to scale with additional guest preferences, room features, and/or other attributes that can be used to match reservations to rooms. For example, a conventional room-assignment platform may include an “automatic assignment” feature that matches reservations to rooms based on guest preferences and room features. As additional reservations, rooms, guest preferences, room features, and/or other attributes are added as matching criteria, the search complexity associated with the automatic assignment feature grows exponentially. Consequently, the process of matching rooms to reservations may become computationally infeasible and/or time out as the complexity of the search increases.

As the foregoing illustrates, what is needed in the art are more effective techniques for processing searches and assignments associated with online requests.

### SUMMARY

One embodiment of the present invention sets forth a technique for processing requests. The technique includes retrieving, from one or more data sources, (i) a plurality of reservations associated with a first time frame and (ii) a plurality of available rooms associated with the first time frame, and for each reservation included in the plurality of reservations, generating a set of valid assignments of one or more rooms included in the plurality of available rooms to the reservation. The technique also includes generating, based on (i) the sets of valid assignments for the plurality of reservations and (ii) a plurality of matching objectives, a first plurality of initial assignments of at least a portion of the plurality of available rooms to the plurality of reservations. The technique further includes performing a check-in process for a first reservation included in the plurality of reservations based on the first plurality of initial assignments.

One technical advantage of the disclosed techniques relative to the prior art is the ability to generate assignments of rooms to reservations in a way that optimizes across complex objectives related to guest preferences, room features, travel-with parties, employee inputs, and/or other attributes while limiting the set of valid assignments to rooms that meet basic requirements associated with the reservations. Consequently, the disclosed techniques reduce the complexity of the search space associated with the assignments, which allows the attributes to be explored and optimized in a computationally feasible manner. Another technical advantage of the disclosed techniques is the ability to periodically and/or continuously update assignments in response to the latest reservation and/or room data, which allows the assignments to be dynamically adapted to new reservations, changes to existing reservations, changes in room availability, changes in guest requests, and/or other time-varying factors. Accordingly, the disclosed techniques are more responsive and less resource-intensive than conventional platforms and/or search tools that involve manual “rework” of assignments to accommodate these time-varying factors. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the server of FIG. 1, according to various embodiments.

FIG. 3 is a more detailed illustration of the optimization module and ranking module of FIG. 2, according to various embodiments.

FIG. 4A illustrates an example set of matching objectives associated with the optimization module of FIG. 2, according to various embodiments.

FIG. 4B illustrates a breakdown of a portion of the matching objectives of FIG. 4A, according to various embodiments.

FIG. 4C illustrates a breakdown of a portion of the matching objectives of FIG. 4A, according to various embodiments.

FIG. 4D illustrates a breakdown of a portion of the matching objectives of FIG. 4A, according to various embodiments.

FIG. 4E illustrates an example set of matching constraints associated with the optimization module of FIG. 2, according to various embodiments.

FIG. 4F illustrates an example set of matching constraints associated with the optimization module of FIG. 2, according to various embodiments.

FIG. 5 illustrates a conversion of an example valid assignment list into a corresponding ranking, according to various embodiments.

FIG. 6 illustrates an example workflow for performing a check-in process associated with a reservation, according to various embodiments.

FIG. 7 is a flow diagram of method steps for processing inventory data, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

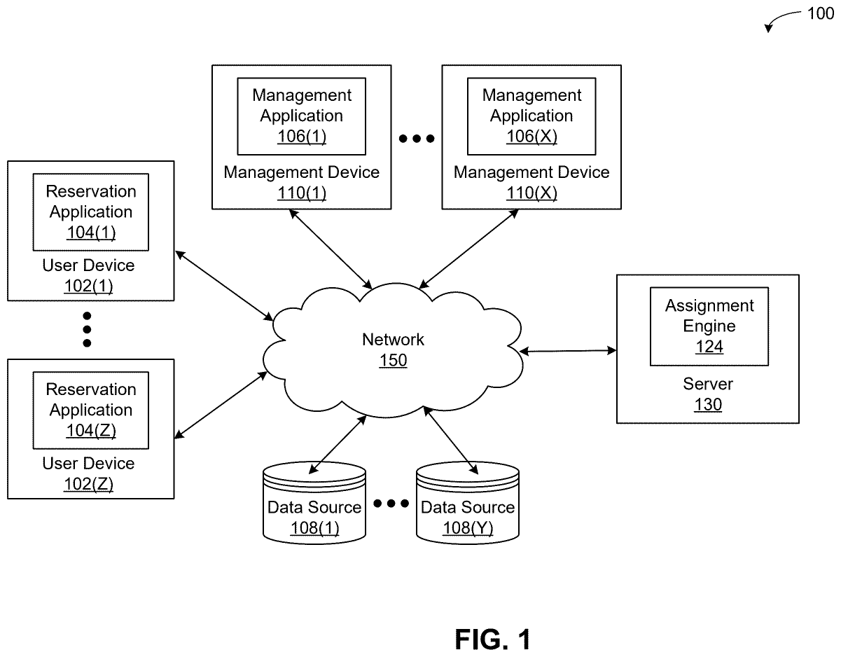

FIG. 1 illustrates a system 100 configured to implement one or more aspects of the present disclosure. As shown, system 100 includes, without limitation, a server 130, a number of user devices 102(1)-102(Z) (each of which is referred to individually herein as user device 102), a number of management devices 110(1)-110(X) (each of which is referred to individually herein as management device 110), and a number of data sources 108(1)-108(Y) (each of which is referred to individually herein as data source 108). Server 130, user devices 102, management devices 110, and data sources 108 communicate via a network 150, which may be a wide area network (WAN), local area network (LAN), WiFi network, cellular network, Ethernet network, the Internet, and/or any other suitable network.

In one or more embodiments, system 100 is configured to generate and manage the assignments of rooms (or other types of inventory) associated with a location, property, property chain, and/or another entity to reservations associated with the entity. Reservations for the rooms can be made via reservation applications 104(1)-104(Z) (each of which is referred to individually herein as reservation application 104) executing on user devices 102. For example, users of personal computers, laptop computers, mobile phones, tablet computers, game consoles, and/or other types of electronic user devices 102 may interact with reservation application 104 to search for available rooms that match a given room type, check-in date, check-out date, price range, party size, location, property, and/or other criteria. The users may also interact with reservation application 104 to make new reservations for available rooms, manage and/or cancel existing reservations, and/or perform online check-in for existing reservations prior to arrival at the corresponding properties.

Management applications 106(1)-106(X) (each of which is referred to individually herein as management application 106) executing on management devices 110 allow employees, administrators, and/or other users to make, modify, review, cancel, and/or otherwise manage reservations on behalf of guests associated with the reservations (e.g., users of user devices 102). Management applications 106 may also, or instead, be used to perform a check-in process for a given reservation (e.g., by a front desk team after a corresponding guest has arrived).

Data sources 108 store records and/or other data associated with reservations, rooms, and/or assignments of reservations to rooms. For example, data sources 108 may include (but are not limited to) databases, data warehouses, filesystems, key-value stores, data streams, and/or other types of data stores and/or communications mechanisms. Data in each data source 108 may be updated on a real-time, near-real-time, and/or periodic basis.

In one or more embodiments, an assignment engine 124 executing on server 130 performs processing related to assignment of rooms to reservations. For example, assignment engine 124 may periodically and/or continually generate and/or update assignments of rooms to reservations on a “look-ahead” basis (e.g., over a future time frame that is defined with respect to the current time). As described in further detail below, these assignments may be generated via one or more optimizations that balance objectives and considerations associated with guest requests, travel-with parties, room availability, room utilization, room type flexibility, employee inputs, and/or other attributes.

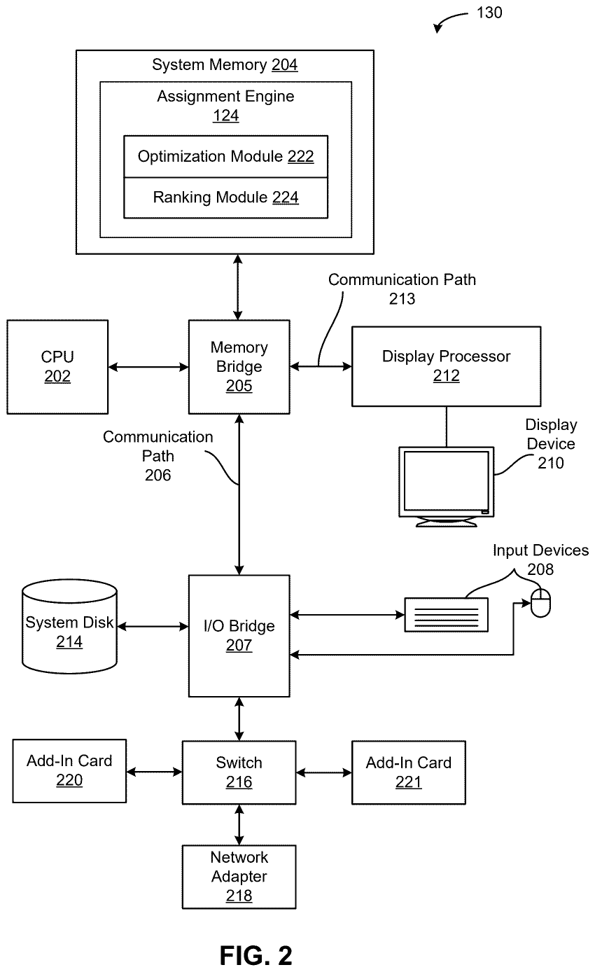

FIG. 2 is a more detailed illustration of server 130 of FIG. 1, according to various embodiments. It is noted that server 130 described herein is illustrative and that any other technically feasible configurations fall within the scope of the present invention. For example, the hardware and/or software components of server 130 may be implemented on user device 102 and/or management device 110. In another example, multiple instances of server 130 may execute on a set of nodes in a data center, cluster, or cloud computing environment to implement the functionality of server 130.

As shown, server 130 includes, without limitation, a central processing unit (CPU) 202 and a system memory 204 coupled to a display processor 212 via a memory bridge 205 and a communication path 213. Memory bridge 205 is further coupled to an I/O (input/output) bridge 207 via a communication path 206, and I/O bridge 207 is, in turn, coupled to a switch 216.

In operation, I/O bridge 207 is configured to receive user input information from input devices 208, such as a keyboard, a microphone, a touchscreen, or a mouse, and forward the input information to CPU 202 for processing via communication path 206 and memory bridge 205. Switch 216 is configured to provide connections between I/O bridge 207 and other components of server 130, such as a network adapter 218 and various add-in cards 220 and 221. Network adapter 218 allows server 130 to communicate with other systems via an electronic communications network (e.g., network 150 of FIG. 1), and may include wired or wireless communication over local area networks and wide area networks such as the Internet.

I/O bridge 207 is coupled to a system disk 214 that may be configured to store content, applications, and data for use by CPU 202 and display processor 212. As a general matter, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within server 130, may be implemented using any technically suitable protocols, including, without limitation, AGP (Accelerated Graphics Port), HyperTransport, or any other bus or point-to-point communication protocol known in the art.

In some embodiments, display processor 212 is coupled to memory bridge 205 via a bus or other communication path (e.g., a PCI Express, Accelerated Graphics Port, or HyperTransport link); in one embodiment display processor 212 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 204.

Display processor 212 periodically delivers pixels to a display device 210 (e.g., a screen or conventional CRT, plasma, OLED, SED or LCD based monitor or television). Additionally, display processor 212 may output pixels to film recorders adapted to reproduce computer generated images on photographic film. Display processor 212 can provide display device 210 with an analog or digital signal.

In various embodiments, display processor 212 is integrated with one or more of the other elements of FIG. 2 to form a single system. For example, display processor 212 may be integrated with CPU 202 and other connection circuitry on a single chip to form a system on chip (SoC).

It will be appreciated that the system shown herein is illustrative and that variations and modifications are possible. The connection topology, including the number and arrangement of bridges, the number of CPUs, and the number of parallel processing subsystems, may be modified as desired. For example, in some embodiments, system memory 204 could be connected to CPU 202 directly rather than through memory bridge 205, and other devices would communicate with system memory 204 via memory bridge 205 and CPU 202. In other alternative topologies, display processor 212 may be connected to I/O bridge 207 or directly to CPU 202, rather than to memory bridge 205. In still other embodiments, I/O bridge 207 and memory bridge 205 may be integrated into a single chip instead of existing as one or more discrete devices. Lastly, in certain embodiments, one or more components shown in FIG. 2 may be absent. For example, switch 216 could be eliminated, and network adapter 218 and add-in cards 220, 221 would connect directly to I/O bridge 207. In another example, display device 210 and/or input devices 208 may be omitted for some or all instances of server 130.

In some embodiments, server 130 is configured to execute assignment engine 124 that resides in system memory 204. Assignment engine 124 may be stored in system disk 214 and/or other storage and loaded into system memory 204 when executed. Additionally, assignment engine 124 includes an optimization module 222 and a ranking module 224.

Optimization module 222 is configured to perform multi-objective optimization of assignments of rooms (or other types of inventory) to reservations. More specifically, optimization module 222 may generate initial “recommended” or “optimal” assignments of available rooms over a future time frame to reservations that fall within and/or overlap with the time frame. Optimization module 222 may also, or instead, generate a set of “valid” assignments for each reservation, where the set of valid assignments includes available rooms that meet the room type, party size, reservation dates, and/or other basic requirements associated with the reservation. These assignments may be generated and/or updated on a periodic, continuous, and/or on-demand basis based on configurable and/or adjustable objectives and/or constraints associated with matching rooms to reservations.

Ranking module 224 generates a ranking of valid assignments for a given reservation that falls within and/or overlaps with a corresponding time frame. The top of the ranking may include the room associated with the initial assignment (e.g., when an initial assignment for the reservation is available), and the remainder of the ranking may be populated with additional rooms in the set of valid assignments for the reservation. The order of rooms in at least a portion of the ranking may be determined based on ranking criteria associated with guest requests, room scarcity, room availability, room utilization, travel-with assignments, and/or other attributes. Optimization module 222 and ranking module 224 are described in further detail below.

### Dynamic Multi-objective Inventory Optimization

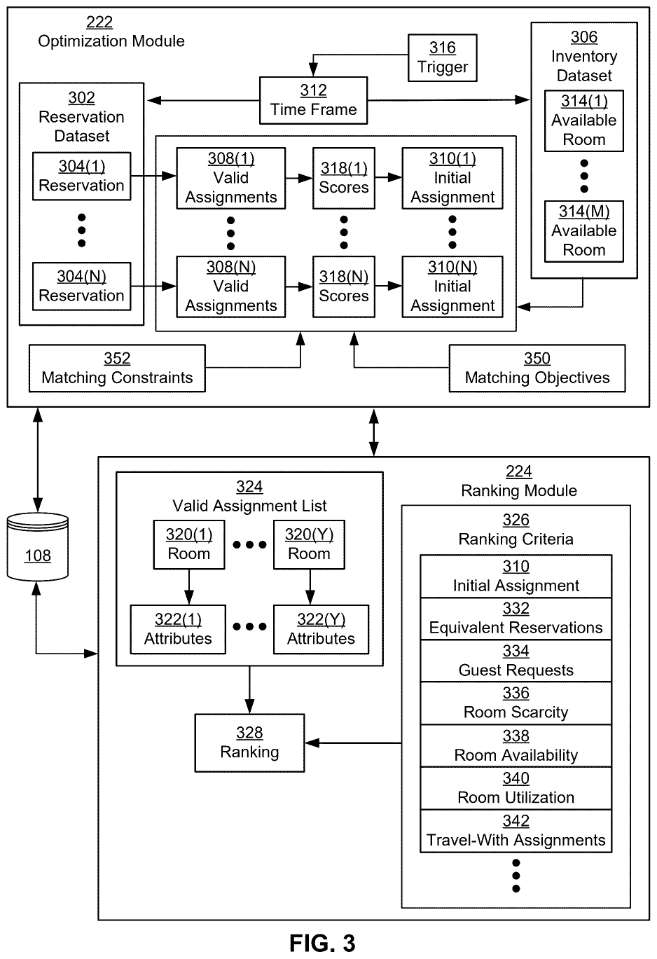

FIG. 3 is a more detailed illustration of optimization module 222 and ranking module 224 of FIG. 2, according to various embodiments. As described above, optimization module 222 generates, on a periodic, continuous, and/or on-demand basis, valid assignments 308(1)-308(N) (each of which is referred to individually herein as valid assignments 308) and initial assignments 310(1)-310(N) (each of which is referred to individually herein as initial assignment 310) between a set of reservations 304(1)-304(N) (each of which is referred to individually herein as reservation 304) in a reservation dataset 302 and a set of available rooms 314(1)-314(M) (each of which is referred to individually herein as available room 314) in an inventory dataset 306.

Reservation dataset 302 and/or inventory dataset 306 may be stored in one or more data sources 108 and retrieved by optimization module 222 via communications with the data source(s) 108 over a network (e.g., network 150 of FIG. 1). Reservation dataset 302 and/or inventory dataset 306 may also, or instead, be stored on a computer system and/or network that is local to one or more instances of optimization module 222.

Reservations 304 include confirmed bookings of rooms (or other types of inventory). For example, each reservation 304 may include a party size (e.g., number of adults and/or children), check-in date, check-out date, room type (e.g., standard, resort view, garden view, deluxe, concierge level, studio, suite, themed room, one-bedroom, two-bedroom, apartment, villa, campsite, etc.), property (e.g., hotel, resort, campground, etc.), and/or other parameters. Each reservation may be made via reservation application 104 executing on a corresponding user device 102, management application 106 executing on a corresponding management device 110, and/or another type of application, interface, and/or mechanism.

In some embodiments, one or more reservations 304 can be made using a given booking, and each reservation 304 is made for a single room. For example, a user may submit a booking for multiple rooms to accommodate multiple people and/or groups of people traveling together. Each room in the booking submitted by the user may be represented in reservation dataset 302 using a different reservation 304 with a corresponding room type, party size, check-in date, check-out date, and/or other parameters. Additionally, these reservations 304 may be associated with the same “travel-with” party to indicate that the corresponding people are traveling together. The size of the travel-with party may correspond to the number of reservations 304 associated with the travel-with party.

Available rooms 314 include rooms that can be used to accommodate guests on a certain date and/or range of dates. For example, available rooms 314 may include all rooms that are not manually “blocked” to fulfill certain reservations 304; rooms that are not subject to repairs, renovations, and/or closures during the date(s); and/or rooms that are physically available to accommodate guests during the date(s). Available rooms 314 may be tracked and/or updated via management application 106 executing on one or more management devices 110 and/or another type of application, interface, and/or mechanism.

In one or more embodiments, each set of initial assignments 310 between reservations 304 in reservation dataset 302 and available rooms 314 in inventory dataset 306 is generated for a given time frame 312. For example, a set of initial assignments 310 may be generated for reservations 304 and/or available rooms 314 that fall within and/or overlap with a corresponding time frame 312 that spans a certain number of days, weeks, and/or other units of time into the future.

Additionally, each initial assignment 310 is selected from a set of valid assignments 308 for the corresponding reservation 304. More specifically, optimization module 222 matches each reservation 304 associated with (e.g., falling within, overlapping with, etc.) a given time frame 312 to a set of valid assignments 308 that includes available rooms 314 that satisfy the room type, reservation period, party sizes, and/or other basic requirements of that reservation 304. For example, optimization module 222 may determine a set of valid assignments 308 for a given reservation 304 by searching and/or filtering available rooms 314 in inventory dataset 306 by parameters of that reservation 304.

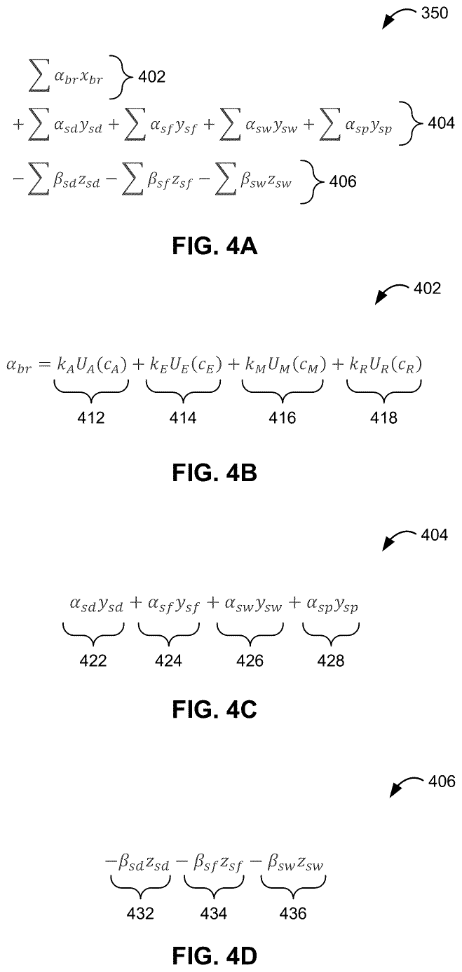

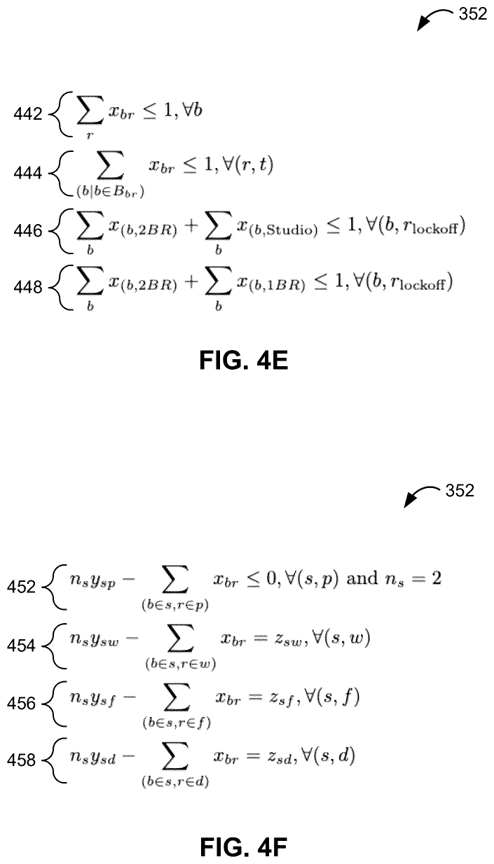

Optimization module 222 also computes a corresponding set of scores 318(1)-318(N) (each of which is referred to individually herein as scores 318) between each reservation 304 and the corresponding set of valid assignments 308. Each score represents the degree to which the corresponding valid assignment satisfies a set of matching objectives 350 associated with assigning available rooms 314 to reservations 304. As described in further detail below with respect to FIGS. 4A-4D, matching objectives 350 may balance priorities associated with guest preferences, room features, travel-with parties, employee inputs, and/or other attributes while meeting requirements and/or constraints associated with reservations 304 and/or available rooms 314.

Optimization module 222 also uses scores 318 and a set of matching constraints 352 to generate a “holistically optimal” set of initial assignments 310 for these reservations 304. For example, optimization module 222 may use a branch and bound technique and/or another assignment optimization technique to select, from valid assignments 308 for individual reservations 304, initial assignments 310 that maximize an “overall” measure of (e.g., average, sum, etc.) scores 318 associated with reservations 304 while satisfying matching constraints 352.

In one or more embodiments, optimization module 222 uses a mixed integer programming technique to generate initial assignments 310 based on a solution space of valid assignments 308 for individual reservations 304 and scores 318 associated with these valid assignments 308 and reservations 304. The mixed integer programming technique uses both integer and non-integer representations of attributes associated with reservations 304 and/or available rooms 314 and weights associated with the attributes to compute scores 318. The weights and/or functions used to calculate the weights can be adjusted to reflect changes in priorities associated with the corresponding matching objectives 350.

FIG. 4A illustrates an example set of matching objectives 350 associated with optimization module 222 of FIG. 2, according to various embodiments. More specifically, FIG. 4A illustrates three different subsets 402, 404, and 406 of matching objectives 350 that represent three different types of priorities associated with assigning available rooms 314 to reservations 304. A first subset 402 of matching objectives 350 is denoted by Σα_{br}x_{br} and represents priorities associated with matching available rooms 314 to individual reservations 304. This subset 402 is computed for pairs of reservations 304 and valid assignments 308 associated with a given time frame 312.

A second subset 404 of matching objectives 350 is denoted by +Σα_{sd}y_{sd}+Σα_{sƒ}y_{sƒ}+Σα_{sw}y_{sw}+Σαₛₚyₛₚ and represents priorities associated with assigning available rooms 314 that are within a certain level of proximity to one another to a travel-with party with multiple reservations 304. This subset 404 is computed for a given set of reservations 304 that is associated with a given time frame 312 and corresponds to a travel-with party size of at least 2.

A third subset 406 of matching objectives 350 is denoted by −πβ_{sƒ}z_{sd}−πβ_{sƒ}z_{sƒ}−Σ_{sw}z_{sw} and represents penalties associated with an inability to assign available rooms 314 that are within a certain level of proximity to one another to a travel-with party with multiple reservations 304. This subset 406 is computed for a given set of reservations 304 that is associated with a given time frame 312 and corresponds to a travel-with party size of greater than 2.

In one or more embodiments, the x, y, and z terms in matching objectives 350 represent decision variables that are used in multi-objective optimization of assignments of available rooms 314 to reservations 304. Within these decision variables, x_{br} is a binary decision variable that denotes the assignment of a given reservation 304 denoted by b to a corresponding available room 314 denoted by r. Similarly, yₛₚ, y_{sw}, y_{sƒ}, and y_{sd} are binary decision variables representing an assignment of some or all reservations denoted by s in the same travel-with party to a connecting pair p (e.g., a pair of adjacent rooms with a door in between), a wing w (e.g., rooms along the same corridor on the same floor of a building), a floor ƒ (e.g., the same floor of a given building), and a building d, respectively. Each binary decision variable is set to 1 if the corresponding assignment is made and to 0 otherwise.

On the other hand, z_{sw}, z_{sƒ}, and z_{sd} are continuous decision variables that pertain to travel-with parties of more than two reservations 304. In particular, z_{sw} represents the number of reservations 304 in travel-with party s that are separated from the rest of the travel-with party in wing w, z_{sƒ} represents the number of reservations 304 in travel-with party s that are separated from the rest of the travel-with party on floor ƒ, and z_{sd} represents the number of reservations 304 in travel-with party s that are separated from the rest of the travel-with party in building d.

As shown in FIG. 4A, each decision variable is scaled by a corresponding weight that is denoted by α or β. The α weights represent rewards associated with favorable assignments for individual reservations 304 and/or travel-with parties, and the β weights represent penalties associated with separating one or more reservations 304 in a travel-with party from the remainder of the travel-with party. Within subset 402, α_{br} represents a reward for assigning reservation 304 b to available room 314 r. For a travel-with party s of size 2, αₛₚ represents a reward for assigning the travel-with party to the same connecting pair p, α_{sw} represents a reward for assigning the travel-with party to the same wing w, α_{sƒ} represents a reward for assigning the travel-with party to the same floor ƒ, and α_{sd} represents a reward for assigning the travel-with party to the same building d.

When the travel-with party s has a size that is greater than 2, αₛₚ is omitted (e.g., because the entire travel-with party cannot be accommodated using a connecting pair), α_{sw} represents a reward for assigning at least one reservation in the travel-with party s to a wing w, α_{sƒ} represents a reward for assigning at least one reservation in the travel-with party s to a floor ƒ, and α_{sd} represents a reward for assigning at least one reservation in the travel-with party s to a building d. Conversely, β_{sw} represents a penalty for separating each reservation 304 in travel-with party s from the remainder of the travel-with party in wing w, β_{sƒ}represents a penalty for separating each reservation 304 in travel-with party s from the remainder of the travel-with party on floor ƒ, and β_{sd} represents a penalty for separating each reservation 304 in travel-with party s from the remainder of the travel-with party in building d.

Summations associated with terms in subsets 402, 404, and 406 indicate that initial assignments 310 are to be performed in a way that maximizes matching objectives 350 across all reservations 304 associated with a given time frame 312. Matching objectives 350 may be computed for different sets of potential initial assignments 310 for the same reservations 304, and the set of potential initial assignments 310 with the highest summed matching objectives 350 may be used as initial assignments 310 for those reservations 304.

FIG. 4B illustrates a breakdown of a portion of matching objectives 350 of FIG. 4A, according to various embodiments. More specifically, FIG. 4B illustrates how the term α_{br} in the first subset 402 of matching objectives 350 is computed.

As mentioned above, α_{br} represents a reward associated with assigning reservation 304 b to available room 314 r. As shown in FIG. 4B, α_{br} is computed as the sum of four different components 412, 414, 416, and 418, which represent four different sets of priorities associated with matching a given reservation 304 to a corresponding available room 314.

Component 412 is denoted by k_{A}U_{A}(c_{A}) and represents the utility associated with assigning reservation 304 b to any available room 314. Component 414 is denoted by k_{E}U_{E}(c_{E}) and represents the utility associated with assigning reservation 304 b to the same available room 314 as an existing assignment (e.g., when the existing assignment is made by an employee and/or administrator). Component 416 is denoted by k_{M}U_{M}(c_{M}) and represents the utility associated with the extent to which available room 314 r matches the room type of reservation 304 b. Component 418 is denoted by k_{R}U_{R}(c_{R}) and represents the utility associated with the extent to which available room 314 r matches guest requests associated with reservation 304 b.

Each component 412, 414, 416, and 418 is associated with a k term, a U term, and a c term. Each c term denotes the extent to which the assignment of reservation 304 b to available room 314 r satisfies the corresponding priority. Each U term includes a function and/or scaling factor that normalizes the corresponding c term to a range from 0 to 1. Each k term is a weight that represents the relative importance of the corresponding component 412, 414, 416, or 418 and/or the contribution of the corresponding component 412, 414, 416, or 418 to subset 402.

Within component 412, c_{A} may be a binary value that is set to 1 when any available room 314 is assigned to reservation 304 r and to 0 otherwise, and U_{A} is set to 1 (because c_{A} already falls within the range of 0 to 1). In certain instances, c_{A} may be discounted for certain reservations 304 (e.g., reservations 304 for regular rooms and/or stays) to prioritize other types of reservations 304 (e.g., timeshare owners, reservations 304 for themed rooms and/or suites, etc.).

Within component 414, c_{E} may be a binary value that is set to 1 when available room 314 r assigned to reservation 304 b is the same as the room in an existing assignment for reservation 304 b and to 0 otherwise. U_{E} may also be set to 1 because no normalization of c_{E} is needed.

Within component 416, c_{M} may be a numeric score that represents the extent to which the room type of available room 314 r matches or satisfies the room type of reservation 304 b, and U_{M} may be used to normalize c_{M} to a value ranging from 0 to 1. When the room type of reservation 304 b exactly matches the room type of available room 314 r, U_{M}(c_{M}) may be set to 1. When the room type of reservation 304 b does not exactly match the room type of available room 314 r, U_{M}(c_{M}) may be set to a value that is less than 1. Component 416 thus allows for a greater set of valid assignments 308 than exact matches between available rooms 314 and room types of reservations 304. For example, component 416 may be used to compute a slightly lower reward for situations such as (but not limited to) swapping between a dedicated two-bedroom villa and a “lock-off” villa that is a combination of a one-bedroom villa and an adjoining studio with a connecting door in between, an upgrade from the room type of a given reservation 304 to one or more levels higher, substituting a specific type of accessible room in a given reservation 304 another type of accessible room that meets the same accessibility needs, swapping between a “generic” suite in a themed property and a themed suite in the same property, and/or substituting a room type that is not associated with accessibility needs in a given reservation 304 with an accessible room.

Within component 418, c_{R} may be a numeric score that reflects the extent to which guest requests associated with reservation 304 _{b} are fulfilled. For example, c_{R} may be computed as the product of a “reservation score” and a “guest request score.” The reservation score may include a sum and/or another aggregation of numeric points that reflects levels of priority for different attributes of reservation 304 b, with a lower priority associated with a shorter stay, smaller party size, a party mix that excludes children, a last-minute booking, and/or a travel-with party and a higher priority associated with a longer stay, larger party size, a party mix that includes children, a booking that was made in advance, and/or a lack of a travel-with party. The guest request score may include a sum and/or another aggregation of numeric points that reflects levels of priority for different types of guest requests, with a default point value assigned to “non-priority” guest requests, a higher point value assigned to configurable and/or property-specific “priority” guest requests, and a highest point value assigned to “special” guest requests (e.g., accessibility requests). After the reservation score and guest request score are multiplied to produce c_{R}, U_{R} is used to scale c_{R} to a value ranging from 0 to 1.

FIG. 4C illustrates a breakdown of a portion of matching objectives 350 of FIG. 4A, according to various embodiments. More specifically, FIG. 4C illustrates four components 422, 424, 426, and 428 of subset 404 of FIG. 4A. As discussed above, subset 404 represents priorities associated with assigning available rooms 314 that are close to one another to a travel-with party with multiple room reservations 304. This subset 404 is computed for a set of reservations 304 that corresponds to a travel-with party size of at least 2.

Within subset 404, yₛₚ, y_{sw}, y_{sƒ}, and y_{sd}are binary decision variables representing an assignment of at least a portion of a set of reservations 304 in the same travel-with party s to rooms with varying levels of proximity to one another. When the travel-with party has a size of 2, yₛₚ, y_{sw}, y_{sƒ}, and y_{sd} are set to 1 if both reservations 304 in the travel-with party are in the same connecting pair p (e.g., a pair of adjacent rooms with a door in between), wing w (e.g., rooms along the same corridor on the same floor of a building), floor ƒ (e.g., the same floor of a given building), floor ƒ (e.g., the same floor of a given building), and building d, respectively. When the travel-with party has a size of greater than 2, yₛₚ is omitted, and y_{sw}, y_{sƒ}, and y_{sd} are set to 1 when at least one reservation 304 in the travel-with party is assigned to wing w, floor ƒ, and building d, respectively. These binary decision variables are multiplied with corresponding rewards of αₛₚ, α_{sw}, α_{sƒ}, and α_{sd}, and the results are summed to produce a sub-score associated with subset 404.

More specifically, component 422 is denoted by α_{sd}y_{sd} and represents the reward associated with assigning one or more reservations 304 from a travel-with party to a given building. Component 424 is denoted by α_{sƒ}y_{sƒ} and represents the reward associated with assigning one or more reservations 304 from the travel-with party to a given floor. Component 426 is denoted by α_{sw} y_{sw} and represents the reward associated with assigning one or more reservations 304 from the travel-with party to a given wing. Component 428 is denoted by αₛₚyₛₚ and represents the reward associated with assigning reservations 304 from the travel-with party to a given connecting pair (for travel-with parties with two reservations 304).

Components 422, 424, 426, and 426 may reflect increasingly large rewards for greater proximity in available rooms 314 assigned to reservations 304 in the same travel-with party. For example, a travel-with party of size 2 that is assigned to the same wing may accrue rewards associated with components 422, 424, and 426 because rooms in the same wing are also on the same floor of the same building. On the other hand, a travel-with party of size 2 that is not assigned to the same building may earn no rewards from subset 404 because yₛₚ, y_{sw}, y_{sƒ}, and y_{sd} are all set to 0.

FIG. 4D illustrates a breakdown of a portion of matching objectives 350 of FIG. 4A, according to various embodiments. In particular, FIG. 4D illustrates three components 432, 434, and 436 of subset 406 of FIG. 4A. As discussed above, subset 406 represents penalties associated with an inability to assign available rooms 314 that are close to one another to a travel-with party with a size of greater than 2.

Within subset 406, z_{sw}, z_{sƒ}, and z_{sd} are continuous decision variables that represent the number of reservations 304 in travel-with party s that are separated from the rest of the travel-with party in wing w, the number of reservations 304 in travel-with party s that are separated from the rest of the travel-with party in floor ƒ, and the number of reservations 304 in travel-with party s that are separated from the rest of the travel-with party in building d, respectively. These decision variables are multiplied by corresponding penalties of β_{sw}, β_{sƒ}, and β_{sd}, and a negative sum of the results is computed to produce a sub-score associated with subset 406.

The computation of subsets 404 and 406 may be illustrated using the following example for a travel-with party of size 3. One set of potential initial assignments 310 for this travel-with party includes room 9101 in building 9, floor 1, wing 1; room 9102 in building 9, floor 1, wing 1; and room 9106 in building 9, floor 1, wing 2. In this example, d=9 and ƒ=1 for all three reservations 304 in the travel-with party, while w=1 for rooms 9101 and 9102 and w=2 for room 9106.

Because all three rooms are in the same building, y_{sd} is set to 1 for the travel-with party, and the reward of α_{sd} from component 422 is applied to the travel-with party. At the same time, z_{sd} is set to 0 for the travel-with party (because no reservation 304 is in a different building), and no penalty associated with component 432 is incurred for the travel-with party.

Similarly, y_{sƒ} is set to 1 for the travel-with party because all three rooms are on the same floor. Consequently, the reward of α_{sƒ} from component 424 is applied to the travel-with party. Further, z_{sƒ} is set to 0 for the travel-party (because no reservation 304 is on a different floor), and no penalty associated with component 434 is incurred for the travel-with party.

When w=1, y_{sw} and z_{sw} are set to 1 for the travel-with party (because at least one reservation 304 is assigned to wing 1 and at least one reservation 304 is assigned to a different wing). Consequently, the travel-with party includes a reward of α_{sw} from component 426 and a penalty of β_{sw} from component 436.

When w=2, y_{sw} is set to 1 for the travel-with party (because at least one reservation 304 is assigned to wing 2), and z_{sw} is set to 2 for the travel-with party (because two other reservations 304 are assigned to a different wing). The travel-with party therefore includes a reward of α_{sw} from component 426 and a penalty of 2β_{sw} from component 436.

Finally, no reward associated with αₛₚγₛₚ from component 428 is computed for this travel-with party because this component 428 applies only to travel-with parties of size 2.

FIG. 4E illustrates an example set of matching constraints 352 associated with optimization module 222 of FIG. 2, according to various embodiments. More specifically, FIG. 4E illustrates four operational constraints 442, 444, 446, and 448 that are used to generate initial assignments 310 of available rooms 314 to individual reservations 304.

As with subset 402 of matching objectives 350 in FIG. 4A, each of operational constraints 442, 444, 446, and 448 includes one or more binary decision variables of the form x_{b}r, which denotes the assignment of a given reservation 304 denoted by b to a corresponding available room 314 denoted by r. Thus, x_{br} is set to 1 when reservation 304 b is assigned to available room 314 r and to 0 otherwise. Each operational constraint 442, 444, 446, and 448 specifies a condition to be met by values of x_{br} for different reservations 304 and/or available rooms 314.

Operational constraint 442 includes the expression Σᵣx_{br}≤1, ∀b. This expression specifies that at most one available room 314 is set as a corresponding initial assignment 310 to a given reservation 304 for all reservations 304 b.

Operational constraint 444 includes the expression Σ_{(b/b∈B}_{_{br}})x_{br}≤1, ∀(r, t). This expression specifies that at most one reservation 304 b is matched to a night t in a given available room 314 r for all assignable pairs of available rooms 314 and nights.

Operational Constraint 446 includes the expression Σ_{b}x_{(b,2BR)}+Σ_{b}x_{(b, Studio)}≤1, ∀(b,r_{lockoff}), and operational constraint 448 includes the expression Σ_{b}x_{(b,2BR)}+Σ_{b}x_{(b,1BR)}≤1, ∀(b,r_{lockoff}). These expressions specify that at most one reservation 304 b is matched to a night t in any two-bedroom (e.g., 2BR) configuration of a lock-off villa (e.g., r_{lockoff}) that is a combination of a one-bedroom villa and an adjoining studio with a connecting door in between. These expressions also allow the one-bedroom villa (e.g., 1BR) and/or studio (e.g., Studio) within the same lock-off villa to be assigned on a given night when the two-bedroom configuration has not been assigned on the same night.

FIG. 4F illustrates an example set of matching constraints 352 associated with optimization module 222 of FIG. 2, according to various embodiments. More specifically, FIG. 4F illustrates four travel-with constraints 452, 454, 456, and 458 that apply to initial assignments 310 of available rooms 314 to reservations 304 in travel-with parties.

Like operational constraints 442, 444, 446, and 448, travel-with constraints 452, 454, 456, and 458 include binary decision variables of the form x_{br}, where x_{br} is set to 1 when a given reservation 304 b is assigned to available room 314 r and to 0 otherwise. Additionally, like subset 404 of matching objectives 350 in FIG. 4A, travel-with constraints 452, 454, 456, and 458 include binary decision variables yₛₚ, y_{sw}, y_{sƒ}, and y_{sd} that represent an assignment of at least a portion of a set of reservations 304 in the same travel-with party s to the same connecting pair, wing, floor, and building, respectively. Each operational constraint 452, 454, 456, and 458 specifies a condition to be met by values of x_{br}, yₛₚ, y_{sw}, y_{sƒ}, and/or y_{sd} for various travel-with parties. Further, each of travel-with constraints 452, 454, 456, and 458 includes a variable ns that represents the number of reservations 304 in travel-with party s.

Operational constraint 452 includes the expression nₛ yₛₚ−Σ_{(b ∈s, r ∈p)}x_{br}≤0, ∀(s, p) and nₛ=2. This expression is used to determine when both reservations 304 in a travel-with party of size 2 are assigned to available rooms 314 in the same connecting pair. When this condition is met (i.e., nₛyₛₚ=2 and Σ_{(b ∈s, r ∈p)}x_{br}=2), a corresponding reward of α_{sd} is applied to the travel-with party.

Operational constraints 454, 456, and 458 include similar expressions of nₛy_{sw}−Σ_{(b ∈s, r ∈w)}x_{br}=z_{sw}, ∀(s, w), nₛy_{sƒ}−Σ_{(b∈s, r∈ƒ)}x_{br}=z_{sƒ}, ∀(s, ƒ) , and nₛy_{sd}−Σ_{(b ∈s, r ∈d)}x_{br}=z_{sd}, ∀(s, d), respectively. These expressions are used to compute values of z_{sw}, z_{sƒ}, and z_{sd}, which are used to determine penalties associated with an inability to assign available rooms 314 that are close to one another to a travel-with party of size greater than 2. More specifically, each expression computes a corresponding z value for travel-party s and a given wing w, floor ƒ, or building d to which at least one reservation 304 in the travel-with party is assigned as the difference between the total number of reservations 304 in the travel-with party and the number of reservations in the same travel-party that are assigned to that wing w, floor ƒ, or building d. This z value can then be scaled by a corresponding β weight to determine a penalty associated with separating a portion of the travel-with party from the remainder of the travel-with party in that wing, floor, or building, as discussed above.

Returning to the discussion of FIG. 3, in one or more embodiments, optimization module 222 generates a new round of valid assignments 308, scores 318, and initial assignments 310 based on a corresponding trigger 316. For example, trigger 316 may reflect a predefined schedule for generating and/or updating valid assignments 308, scores 318, and/or initial assignments 310. This predefined schedule may specify that valid assignments 308, scores 318, and/or initial assignments 310 that span a given time frame 312 are to be generated and/or updated a certain number of times in a given day preceding that time frame 312. This predefined schedule may also, or instead, specify that valid assignments 308, scores 318, and/or initial assignments 310 are to be generated for a given time frame 312 that is a certain time interval from the current time (e.g., a certain number of minutes, hours, days, etc. from the current time). This predefined schedule may also, or instead, reflect the rate at which reservation dataset 302 and/or inventory dataset 306 are updated (e.g., within one or more corresponding data sources 108). As the current time advances into the next day, time frame 312 may be shifted forward by a day, so that valid assignments 308, scores 318, and/or initial assignments 310 generated during that next day pertain to the new, shifted time frame 312.

In another example, trigger 316 may include a request by an administrator and/or another user to generate and/or update valid assignments 308, scores 318, and/or initial assignments 310. The request may specify a certain time frame 312 and/or other parameters associated with the generation of valid assignments 308, scores 318, and/or initial assignments 310.

In a third example, trigger 316 may reflect demand associated with available rooms 314. Thus, trigger 316 may be more frequent for time frames associated with periods of high or peak travel and less frequent for time frames associated with periods of lower travel.

In some embodiments, “virtual” reservations are included in the multi-objective optimization associated with matching objectives 350 to improve utilization of available rooms 314. Each virtual reservation corresponds to a fake reservation with a corresponding set of parameters (e.g., party size, check-in date, check-out date, room type, property, etc.). Virtual reservations may be created and/or updated by optimization module 222 and/or a user (e.g., an employee and/or administrator) for a given time and/or time frame 312 based on the occupancy rate for a corresponding set of available rooms 314 (e.g., within a building, property, location, etc.). Each virtual reservation may be set to a certain length (e.g., a certain number of days) to reduce the likelihood of “holes” of less than that length between reservations 304 assigned to a given available room 314. For example, a virtual reservation that spans four days beginning on the check-out date of a real reservation 304 may be assigned to the same available room 314 as the real reservation 304 to allow for a longer contiguous period of availability for that available room 314 beginning on the check-out date. The virtual reservation may also, or instead, be used to remove a short gap (e.g., 1-2 nights) between the real reservation 304 and another real reservation 304 with a previous initial assignment 310 to the same available room 314 by causing the other real reservation 304 to be assigned to a different available room 314. Each virtual reservation may be associated with a low score for a given available room 314 to avoid scenarios where the virtual reservation displaces a real reservation 304 during the generation of initial assignments 310.

After a given round of valid assignments 308, scores 318, and/or initial assignments 310 is generated by optimization module 222, ranking module 224 obtains a valid assignment list 324 for each corresponding reservation 304. For example, ranking module 224 may obtain valid assignment list 324 as a default ordering of rooms 320 in a set of valid assignments 308 for a given reservation 304. Ranking module 224 also uses attributes 322(1)-322(Y) (each of which is referred to individually herein as attributes 322) associated with each room 320 in valid assignment list 324 and a set of ranking criteria 326 to generate a corresponding ranking 328 of rooms 320 from valid assignment list 324. This ranking 328 may represent an ordering of rooms 320 by descending “suitability” for assignment to that reservation 304.

In one or more embodiments, ranking criteria 326 include representations of importance associated with various attributes 322 of rooms 320 in valid assignment list 324. For example, ranking criteria 326 may include weights, priorities, and/or formulas that can be used to convert attributes 322 (e.g., room types, room classes, building floors, accessibility features, current and/or future availabilities, etc.) of rooms 320 into corresponding scores. These scores may be used to sort rooms 320 into ranking 328, so that rooms 320 with higher scores are placed higher in ranking 328 and rooms 320 with lower scores are placed lower in ranking 328. In another example, ranking criteria 326 may include rules that are used to sort rooms 320 within ranking 328 and/or filter rooms 320 in valid assignment list 324 from ranking 328.

As shown in FIG. 3, ranking criteria 326 may include initial assignment 310 of a certain room 320 within valid assignment list 324 to that reservation 304. This initial assignment 310 may be placed at the top of ranking 328 to reflect the optimization performed by optimization module 222.

Ranking criteria 326 may also, or instead, include rooms 320 associated with equivalent reservations 332, which have the same check-in date, check-out date, room type, and/or other attributes 322 as those of that reservation 304. Ranking criteria 326 may also, or instead, include considerations for rooms 320 that satisfy or do not satisfy guest requests 334 associated with that reservation 304 and/or other reservations 304. Ranking criteria 326 may also, or instead, include measures of room scarcity 336 (e.g., the extent to which attributes 322 associated with a given room 320 are scarce) and/or room availability 338 (e.g., current availability, future availability, etc.). Ranking criteria 326 may also, or instead, include changes in room utilization 340 that would occur if a given room 320 in valid assignment list 324 were assigned to that reservation 304. Ranking criteria 326 may also, or instead, include changes that would be made to travel-with assignments 342 associated with that reservation 304 and/or other reservations 304 if a given room 320 in valid assignment list 324 were assigned to that reservation 304. In general, the number and types of ranking criteria 326 may be configured for individual reservations 304, groups of reservations 304, types of available rooms 314 (e.g., available rooms 314 associated with different buildings, properties, locations, etc.), time frames, and/or other circumstances.

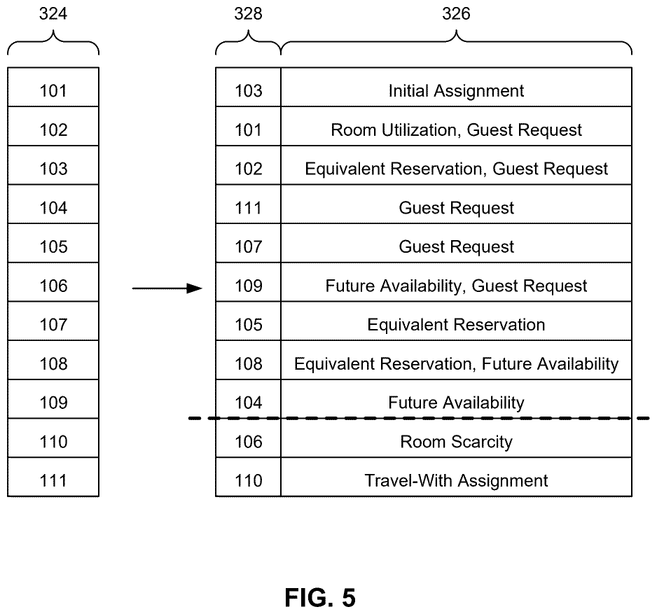

FIG. 5 illustrates a conversion of an example valid assignment list 324 into a corresponding ranking 328, according to various embodiments. As shown in FIG. 5, the valid assignment list 324 includes a numeric sorting of rooms numbered 101 to 111. This numeric sorting is converted into ranking 328, where each room in ranking 328 occupies a position that is determined based on one or more corresponding ranking criteria 326.

More specifically, the top position in ranking 328 is occupied by room 103 because of ranking criteria 326 that identify that room as the initial assignment for a corresponding reservation. The second position in ranking 328 corresponds to room 101 and is due to ranking criteria 326 that identify the room as increasing room utilization (e.g., by filling a hole in between two other reservations assigned to that room) and fulfilling a guest request. The third position in ranking 328 includes room 102 and is a result of ranking criteria 326 that identify the room as being assigned to an equivalent reservation and fulfilling a guest request. The fourth and fifth positions in ranking 328 are occupied by rooms 111 and 107, respectively, because these rooms satisfy guest requests associated with the reservation.

Room 109 is placed in the sixth position in ranking 328 because of ranking criteria 326 related to a future availability of the room and guest requests associated with the reservation. More specifically, the future availability of room 109 may indicate that a “hole” could be created by assigning this room to the corresponding reservation, which adversely impacts the position of the room in ranking 328. On the other hand, room 109 matches one or more guest requests associated with the reservation, which positively impacts the position of the room in the ranking.

Room 105 is in the seventh position in ranking 328 because of ranking criteria 326 that indicate that the room is assigned to an equivalent reservation. Room 108 is in the eighth position in ranking 328 because of ranking criteria 326 that indicate that the room is assigned to an equivalent reservation (which positively impacts the position of the room in ranking 328) and a future availability of this room indicates a possibility of creating a “hole” by assigning this room to the corresponding reservation (which negatively impacts the position of the room in ranking 328). Room 104 is in the ninth position in ranking 328 because of ranking criteria 326 related to a future availability of the room resulting in a potential “hole” if the room is assigned to the corresponding reservation. Room 106 is in the tenth position in ranking 328 because of ranking criteria 326 that identify one or more attributes of the room as scarce. Room 110 is in the last position in ranking because of ranking criteria 326 that identify the room as assigned to a different travel-with party.

In one or more embodiments, ranking 328 is truncated based on additional ranking criteria 326 related to the length of ranking 328. For example, rooms 106 and 110 may be dropped from the bottom of ranking 328 to avoid making suboptimal assignments, optimize for an “ideal” ranking 328 size, and/or reflect other priorities and/or considerations.

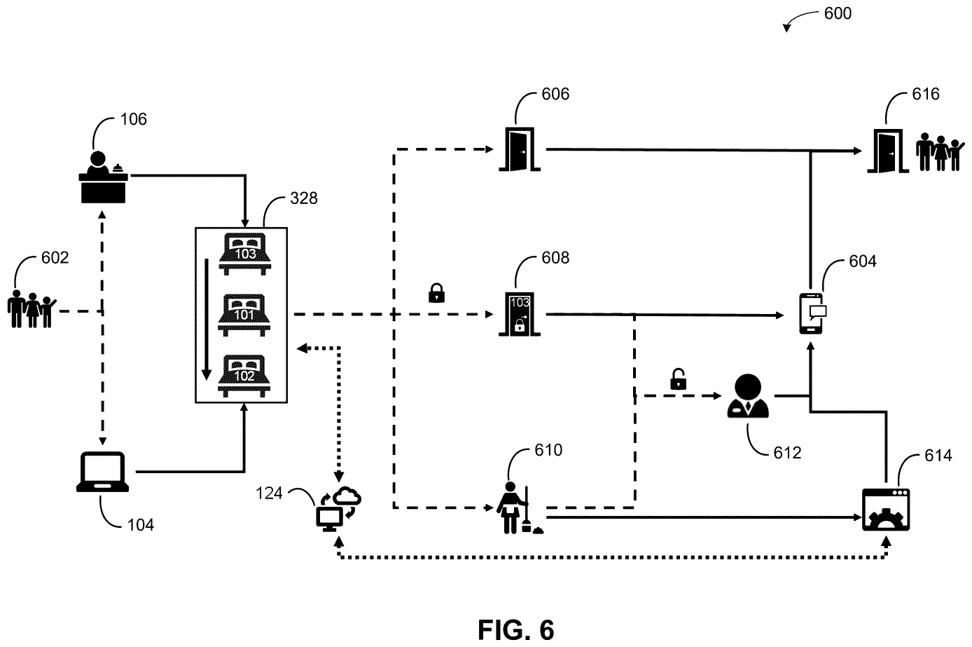

Returning to the discussion of FIG. 3, after a given round of valid assignments 308, scores 318, initial assignments 310, and/or rankings of valid assignments 308 are generated for reservations 304 associated with a certain time frame 312, optimization module 222 and/or ranking module 224 store these valid assignments 308, scores 318, initial assignments 310, and/or rankings in one or more data sources 108. During a check-in process for a given reservation 304, management application 106, reservation application 104, and/or other another component may retrieve the stored data from data sources 108 and use the data to select a final room for that reservation 304. The component may also complete the check-in process by communicating the final room to a user associated with that reservation 304 (e.g., a guest checking in under that reservation 304), generating a digital key to access the final room, and/or performing other actions to facilitate the entry of the user into the final room, as described in further detail below with respect to FIG. 6.

In one or more embodiments, newer rounds of valid assignments 308, scores 318, initial assignments 310, and/or rankings of valid assignments 308 that are generated using more up-to-date data from reservation dataset 302 and inventory dataset 306 are used to “override” or replace previously generated rounds of valid assignments 308, scores 318, and/or initial assignments 310. For example, a more recent round of initial assignments 310 may include a reassignment of one or more available rooms 314 from a previous round of initial assignments 310 to a different set of reservations 304 than the previous round of initial assignments 310. The previous round of initial assignments 310 may also be overwritten in data sources 108 by the more recent round of initial assignments 310, so that the more recent round of initial assignments 310 (and corresponding valid assignments 308 and/or rankings of valid assignments 308) can be used by users of management application 106 to pre-assign available rooms 314 to reservations 304 and/or perform check-in for reservations 304. Each round of initial assignments 310 may also, or instead, be stored in association with a corresponding timestamp, so that management application 106 retrieves the latest initial assignments 310 during pre-assignment of available rooms 314 to reservations 304 and/or check-in for reservations 304.

In some embodiments, matching objectives 350, ranking criteria 326, time frame 312, trigger 316, and/or other parameters used to determine valid assignments 308, initial assignments 310, and/or ranking 328 may be adjusted over time based on guest feedback, performance metrics, changes in priorities, and/or other criteria associated with assignments of available rooms 314 to reservations 304. For example, parameters used to determine valid assignments 308, matching objectives 350, and/or ranking criteria 326 may be added, removed, modified, and/or otherwise configured to adjust the search space associated with initial assignments 310, the complexity associated with optimizing initial assignments 310, and/or other factors that affect the generation of valid assignments 308, initial assignments 310, and/or rankings of valid assignments 308.

In another example, multiple sets of parameters used to determine valid assignments 308, matching objectives 350, and/or ranking criteria 326 may be stored in data sources 108 and used to generate multiple corresponding sets of valid assignments 308, initial assignments 310, and/or rankings of valid assignments 308 for a given time frame 312. These sets of valid assignments 308, initial assignments 310, and/or rankings of valid assignments 308 may be evaluated by users, machine learning models, and/or other mechanisms, and a “best performing” set of valid assignments 308, initial assignments 310, and/or rankings of valid assignments 308 may be selected for use in pre-assigning available rooms 314 to reservations 304 in that time frame 312 and/or performing check-in for reservations 304 in that time frame 312. Alternatively or additionally, a single set of parameters used to determine valid assignments 308, matching objectives 350, and/or ranking criteria 326 may be selected for a given trigger 316 and used to generate corresponding valid assignments 308, initial assignments 310, and/or rankings of valid assignments 308. The selection of parameters for determining valid assignments 308, matching objectives 350, and/or ranking criteria 326 may be performed based on requirements and/or priorities associated with latency, resource consumption, optimization complexity, and/or other factors.

In a third example, parameters and/or weights associated with matching objectives 350 and/or ranking criteria 326 may be included in and/or estimated using one or more neural networks, regression models, tree-based models, support vector machines, and/or other types of machine learning models. These machine learning model(s) may be trained and/or retrained over time using reinforcement learning techniques and/or supervised learning techniques that incorporate user feedback and/or performance metrics associated with initial assignments 310, scores 318, valid assignments 308, rankings, and/or final assignments of rooms to reservations 304. Consequently, the parameters and/or weights may be adjusted over time to produce initial assignments 310, scores 318, valid assignments 308, rankings, and/or final assignments that improve the user feedback and/or performance metrics.

In a fourth example, a genetic programming technique may be used to generate multiple sets of matching objectives 350 and/or ranking criteria 326. These sets of matching objectives 350 and/or ranking criteria 326 may be used to generate multiple corresponding sets of initial assignments 310 and/or rankings of valid assignments 308. Each set of initial assignments 310 and/or rankings may also be associated with a score that represents the extent to which the set of initial assignments 310 and/or rankings satisfy requirements and/or priorities associated with guest requests, employee inputs, room types, travel-with parties, room utilization, and/or other attributes. This score may be generated by a user, a machine learning model, a set of rules, and/or another technique. This score may then be used to select a subset of matching objectives 350 and/or ranking criteria 326 that result in the best scores, and the selected matching objectives 350 and/or ranking criteria 326 may be used to “evolve” a new generation of matching objectives 350 and/or ranking criteria 326. The process may be repeated so that subsequent generations of matching objectives 350 and/or ranking criteria 326 result in initial assignments 310 and/or rankings with increased scores.

FIG. 6 illustrates an example workflow 600 for performing a check-in process associated with a reservation, according to various embodiments. As shown in FIG. 6, workflow 600 begins with an initiation of the check-in process for a guest 602. For example, guest 602 may initiate the check-in process by performing online check-in using reservation application 104 and arriving at the corresponding property, with the arrival of guest 602 at the property determined using geofencing techniques. Guest 602 may also, or instead, approach the front desk at the property. In response to the arrival of guest 602, an employee at the front desk may interact with management application 106 to initiate the check-in process.

After the check-in process is initiated, an application programming interface (API) with assignment engine 124 is used to retrieve the latest ranking 328 of valid assignments for the reservation, as well as the latest housekeeping status for each room in the ranking. The housekeeping status may progress from “dirty” (e.g., after a previous guest has checked out) to “housekeeper in room” to “clean” to “inspected.” After the housekeeping status of a given room is set to “inspected,” the room is ready for check-in.

In some embodiments, ranking 328 is updated based on housekeeping statuses for rooms in ranking 328. For example, the position of a room that is scheduled to be cleaned earlier and/or with a better housekeeping status may be increased within ranking 328.

Housekeeping schedules may also, or instead, be updated based on positions of rooms in ranking 328. For example, a room with a higher position in ranking 328 may be prioritized for cleaning over a room with a lower position in ranking 328.

When ranking 328 has at least one room that is ready for check-in (e.g., at least one room with an “inspected” housekeeping status), a highest-ranked room 606 that is ready for check-in is assigned to the reservation. If no rooms in the ranking are ready for check-in, a room 610 with the best housekeeping status (e.g., the room that is the closest to being ready for check-in) is assigned to the reservation, and the API (or another source of housekeeping data) is periodically queried for an updated housekeeping status 614 for each room.

Alternatively, a room 608 in ranking 328 may be pre-assigned to the reservation prior to the arrival of guest 602. For example, an employee may use management application 106 to pre-assign the highest room in ranking 328 to the reservation a certain number of days before the arrival of guest 602 to “lock in” the most optimal room assignment for the reservation. When the pre-assigned room 608 is not ready for check-in (e.g., because the pre-assigned room 608 has not been cleaned and inspected), a user 612 (e.g., the same employee and/or a different employee) may use the latest housekeeping status 614 to override the pre-assignment with a different room in ranking 328 that is ready for check-in and/or that has a better housekeeping status.

Once the room that is assigned to the reservation is ready for check-in, an update 604 is transmitted to reservation application 104 for guest 602 to provide information that can be used to automatically complete the check-in process. This information may include (but is not limited to) a room number for the room, directions to the room, and/or a digital key for the room and/or other areas within a corresponding property. Guest 602 may use the received information to proceed 616 to the room. Management application 106 may also, or instead, be updated to indicate that the check-in process for the reservation has been completed using the room.

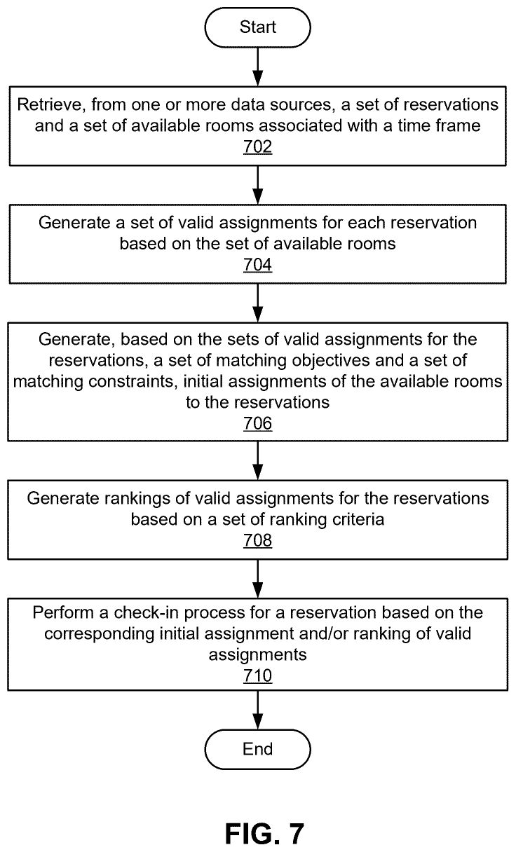

FIG. 7 is a flow diagram of method steps for processing inventory data, according to various embodiments. Although the method steps are described in conjunction with the systems of FIGS. 1-3, persons skilled in the art will understand that any system configured to perform the method steps in any order falls within the scope of the present disclosure.

As shown, in operation 702, optimization module 222 retrieves, from one or more data sources, a set of reservations and a set of available rooms associated with a time frame. For example, optimization module 222 may search one or more data sources for reservations and/or available rooms that fall within and/or overlap with a given future time frame.

In operation 704, optimization module 222 generates a set of valid assignments for each reservation based on the set of available rooms. For example, optimization module 222 may match each reservation to a subset of available rooms that meet the room type, party size, and/or dates of the reservation.

In operation 706, optimization module 222 generates, based on 1) the sets of valid assignments for the reservations, 2) a set of matching objectives, and 3) a set of matching constraints, initial assignments of the available rooms to the reservations. For example, optimization module 222 may use the matching objectives, matching constraints, attributes of the reservations, and/or attributes of rooms in valid assignments for the reservations to compute scores between each reservation and one or more rooms included in a corresponding set of valid assignments. Optimization module 222 may also use a mixed integer programming technique and/or another type of optimization technique to optimize for initial assignments that maximize an aggregation of the corresponding scores while meeting the matching constraints.

In operation 708, ranking module 224 generates rankings of valid assignments for the reservations based on a set of ranking criteria. For example, ranking module 224 may add the initial assignment of a room to a reservation to the top of the ranking for the reservation. Ranking module 224 may use additional ranking criteria related to guest requests, equivalent reservations, current room availability, future room availability, room scarcity, travel-with assignments, room utilization, and/or other attributes to sort remaining rooms in valid assignments for the reservation within the ranking and/or omit certain rooms from the ranking.

In operation 710, management application 106 and/or reservation application 104 perform a check-in process for a reservation based on the corresponding initial assignment and/or ranking of valid assignments. For example, management application 106 and/or reservation application 104 may initiate the check-in process based on user input from a user associated with the reservation, interaction between the user and an employee, and/or other activity associated with the user. During the check-in process, management application 106 and/or reservation application 104 may retrieve the ranking of valid assignments for the reservation and a housekeeping status for each room in the ranking. Management application 106 and/or reservation application 104 may also assign, to the reservation, the highest-ranked room in the ranking with a housekeeping status that indicates that the room is ready for check-in. Management application 106 and/or reservation application 104 may also, or instead, preserve an existing “pre-assignment” of a room in the ranking to the reservation. Once the currently assigned room is ready for check-in, management application 106 and/or reservation application 104 may complete the check-in process by transmitting the room number of the room, directions to the room, a digital key for the room, and/or other information that can be used to access the room to the user.

In sum, the disclosed techniques perform multi-objective optimization of assignments of rooms (or other types of inventory) to reservations. The multi-objective optimization is performed on a periodic, continuous, and/or on-demand basis for a given future time frame (e.g., a certain number of days or weeks after the current date or time). During the multi-objective optimization, a set of valid assignments is determined for each reservation that partially and/or completely falls within the future time frame. The set of valid assignments may include a set of available rooms that meet requirements associated with a room type, group size, and/or time period for the reservation.

A set of scores is computed between each reservation and one or more rooms included in the corresponding set of valid assignments. Each score may be computed using an objective function that combines a first set of objectives associated with assigning a given room to a reservation and a second set of objectives associated with assigning multiple rooms to a travel-with party with multiple room reservations. The scores are also used to generate a “holistically optimal” set of initial assignments to the reservations (e.g., assignments of rooms to reservations that maximize a sum and/or another aggregation of the corresponding scores). Weights and/or parameters of the objective function may be updated over time using machine learning and/or data-driven optimization techniques to adapt and/or improve the initial assignments to outcomes, performance metrics, priorities, and/or other factors.

A ranking of valid assignments is also generated for each reservation. The top of the ranking includes the room associated with the initial assignment, and the remainder of the ranking may be populated with other rooms in the set of valid assignments. The order of rooms in the remainder of the ranking may be determined based on ranking criteria associated with guest requests, room scarcity, room availability, room utilization, travel-with assignments, and/or other attributes that reflect the “suitability” of the rooms for assignment to the reservation.

The disclosed techniques are also configured to automatically perform a check-in process for a given reservation using the corresponding ranking. During the check-in process (e.g., after a guest has arrived at a property and/or performed online check-in ahead of the arrival), an API is used to retrieve the latest ranking of valid assignments for the reservation and the latest housekeeping status for each room in the ranking. When the ranking has at least one room with a housekeeping status that indicates a readiness for check-in (e.g., after a room has been cleaned and inspected), the highest-ranked room that is ready for check-in is assigned to the reservation. If no rooms in the ranking are ready for check-in, the API (or another source of housekeeping data) is periodically queried for an updated housekeeping status for each room, and the room with the best housekeeping status (e.g., the room that is the closest to being ready for check-in) is assigned to the reservation.

Alternatively, a room in the ranking may be pre-assigned to the reservation (e.g., by an employee at the corresponding property) prior to check-in. If the pre-assigned room is not ready for check-in (e.g., because the pre-assigned room has not been cleaned and inspected) after the check-in process is initiated, the pre-assigned room may be replaced with a different room in the ranking that is ready for check-in and/or a different room with a better housekeeping status (e.g., by the same employee and/or a different user).

Once a room that is currently assigned to the reservation is ready for check-in, the check-in process is automatically completed via one or more devices. For example, a mobile device of a user associated with the reservation (e.g., a guest for which the reservation was made) may be updated with a room number for the room, a digital key for the room and/or other areas within a corresponding property, and/or other information and/or functionality that allows the user to access the room.

One technical advantage of the disclosed techniques relative to the prior art is the ability to generate assignments of rooms to reservations in a way that optimizes across complex objectives related to guest preferences, room features, travel-with parties, employee inputs, and/or other attributes while limiting the set of valid assignments to rooms that meet basic requirements associated with the reservations. Consequently, the disclosed techniques reduce the complexity of the search space associated with the assignments, which allows the attributes to be explored and optimized in a computationally feasible manner. Another technical advantage of the disclosed techniques is the ability to periodically and/or continuously update assignments in response to the latest reservation and/or room data, which allows the assignments to be dynamically adapted to new reservations, changes to existing reservations, changes in room availability, changes in guest requests, and/or other time-varying factors. Accordingly, the disclosed techniques are more responsive and less resource-intensive than conventional platforms and/or search tools that involve manual “rework” of assignments to accommodate these time-varying factors. Further, the integration of the assignments with up-to-date information on housekeeping status into a check-in workflow allows the check-in workflow to be streamlined and/or automated based on guest arrival times and up-to-date room readiness, which further reduces latency and resource overhead over conventional computer-based check-in workflows. An additional technical advantage of the disclosed techniques is the adaptation of objectives and/or weights used to optimize the initial assignments to outcomes, performance metrics, and/or other “targets” associated with assignments of rooms to reservations. Accordingly, the disclosed techniques may be used to “train” and/or improve machine learning models and/or components associated with the objectives using corresponding data and outcomes. These technical advantages provide one or more technological improvements over prior art approaches.
1. In some embodiments, a computer-implemented method for processing requests comprises retrieving, from one or more data sources, (i) a plurality of reservations associated with a first time frame and (ii) a plurality of available rooms associated with the first time frame; for each reservation included in the plurality of reservations, generating a set of valid assignments of one or more rooms included in the plurality of available rooms; generating, based on (i) the sets of valid assignments for the plurality of reservations and (ii) a plurality of matching objectives, a first plurality of initial assignments of at least a portion of the plurality of available rooms to the plurality of reservations; and performing a check-in process for a first reservation included in the plurality of reservations based on the first plurality of initial assignments.
2. The computer-implemented method of clause 1, further comprising retrieving, from the one or more data sources, (i) an additional plurality of reservations associated with a second time frame and (ii) an additional plurality of available rooms associated with the second time frame; and generating a second plurality of initial assignments of at least a portion of the additional plurality of available rooms to the additional plurality of reservations, wherein the second plurality of initial assignments includes a reassignment of a room included in the at least a portion of the plurality of available rooms to a second reservation included in the additional plurality of reservations.
3. The computer-implemented method of any of clauses 1-2, wherein the second plurality of initial assignments is generated based on a time interval between a current time and at least one time included in the second time frame.
4. The computer-implemented method of any of clauses 1-3, further comprising generating, for the first reservation, a ranking of a corresponding set of valid assignments based on a set of ranking criteria, wherein performing the check-in process for the first reservation is further based on the ranking.
5. The computer-implemented method of any of clauses 1-4, wherein performing the check-in process for the first reservation further based on the ranking comprises assigning, to the first reservation, a highest-ranked room that is (i) included in the ranking and (ii) ready for check-in.
6. The computer-implemented method of any of clauses 1-5, wherein generating the ranking comprises populating a top of the ranking with a first room from an initial assignment that is (i) included in the first plurality of initial assignments and (ii) associated with the first reservation; and adding a set of additional rooms from the set of valid assignments for the first reservation to a set of positions below the top of the ranking based on a plurality of factors associated with the set of additional rooms.
7. The computer-implemented method of any of clauses 1-6, wherein the plurality of factors comprises at least one of a guest request, an equivalent reservation, a current availability, a future availability, a room scarcity, a travel-with assignment, or a room utilization.
8. The computer-implemented method of any of clauses 1-7, wherein generating the first plurality of initial assignments comprises for each reservation included in the plurality of reservations, computing a set of scores between the reservation and a corresponding set of valid assignments based on the plurality of matching objectives; and determining the first plurality of initial assignments via an optimization associated with the sets of scores for the plurality of reservations.
9. The computer-implemented method of any of clauses 1-8, wherein computing the set of scores comprises computing a first portion of a score included in the set of scores based on a first subset of the plurality of matching objectives associated with the reservation.
10. The computer-implemented method of any of clauses 1-9, wherein computing the set of scores further comprises computing a second portion of the score based on a second subset of the plurality of matching objectives associated with a travel-with party for the reservation.
11. The computer-implemented method of any of clauses 1-10, wherein the second subset of the plurality of matching objectives comprises at least one of a proximity between members of the travel-with party or a separation between members of the travel-with party.
12. The computer-implemented method of any of clauses 1-11, wherein the first subset of the plurality of matching objectives comprises at least one of an assignment of a room to the reservation, a preservation of an existing room assignment for the reservation, a fit between a first room type of the reservation and a second room type for the room, or a fulfillment of a guest request associated with the reservation.
13. In some embodiments, one or more non-transitory computer-readable media store instructions that, when executed by one or more processors, cause the one or more processors to perform the steps of retrieving, from one or more data sources, (i) a plurality of reservations associated with a first time frame and (ii) a plurality of available rooms associated with the first time frame; for each reservation included in the plurality of reservations, generating a set of valid assignments of one or more rooms included in the plurality of available rooms; generating, based on (i) the sets of valid assignments for the plurality of reservations and (ii) a plurality of matching objectives, a first plurality of initial assignments of at least a portion of the plurality of available rooms to the plurality of reservations; and performing a check-in process for a first reservation included in the plurality of reservations based on the first plurality of initial assignments.
14. The one or more non-transitory computer-readable media of clause 13, wherein the instructions further cause the one or more processors to perform the steps of after the first plurality of initial assignments is generated, retrieving, from the one or more data sources, (i) an updated plurality of reservations associated with the first time frame and (ii) an updated plurality of available rooms associated with the first time frame; and generating a second plurality of initial assignments of at least a portion of the updated plurality of available rooms to at least a portion of the updated plurality of reservations, wherein the second plurality of initial assignments includes a reassignment of a room included in the at least a portion of the plurality of available rooms to a second reservation included in the updated plurality of reservations.
15. The one or more non-transitory computer-readable media of any of clauses 13-14, wherein the updated plurality of reservations and the updated plurality of available rooms are retrieved based on at least one of a level of demand associated with the first time frame, an elapsed time since the first plurality of initial assignments was generated, or an availability of the updated plurality of reservations or the updated plurality of available rooms.
16. The one or more non-transitory computer-readable media of any of clauses 13-15, wherein generating the set of valid assignments comprises matching at least one of a room type, a group size, or a time period associated with the reservation to the one or more rooms.
17. The one or more non-transitory computer-readable media of any of clauses 13-16, wherein generating the first plurality of initial assignments comprises training a machine learning model that comprises a plurality of weights associated with the plurality of matching objectives based on a set of previous assignments and a set of outcomes associated with the set of previous assignments; and generating, via execution of the trained machine learning model, the first plurality of initial assignments.
18. The one or more non-transitory computer-readable media of any of clauses 13-17, wherein performing the check-in process comprises automatically executing the check-in process upon detecting, via a mobile device of a user associated with the first reservation, a proximity of the user to a property associated with the plurality of available rooms.
19. The one or more non-transitory computer-readable media of any of clauses 13-18, wherein the first plurality of initial assignments is generated using a mixed integer programming technique.
20. In some embodiments, a system comprises one or more memories that store instructions, and one or more processors that are coupled to the one or more memories and, when executing the instructions, are configured to perform the steps of retrieving, from one or more data sources, (i) a plurality of reservations associated with a first time frame and (ii) a plurality of available rooms associated with the first time frame; for each reservation included in the plurality of reservations, generating a set of valid assignments of one or more rooms included in the plurality of available rooms based on (i) a first set of attributes associated with the reservation and (ii) a second set of attributes associated with the plurality of available rooms; generating, based on (i) the sets of valid assignments for the plurality of reservations and (ii) a plurality of matching objectives, a first plurality of initial assignments of at least a portion of the plurality of available rooms to the plurality of reservations; and performing a check-in process for a first reservation included in the plurality of reservations based on the first plurality of initial assignments.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing requests, the method comprising:
retrieving, from one or more data sources, (i) a plurality of reservations associated with a first time frame and (ii) a plurality of available rooms associated with the first time frame;
for each reservation included in the plurality of reservations, generating a set of valid assignments of one or more rooms included in the plurality of available rooms;
generating, based on (i) the sets of valid assignments for the plurality of reservations and (ii) a plurality of matching objectives, a first plurality of initial assignments of at least a portion of the plurality of available rooms to the plurality of reservations; and
performing a check-in process for a first reservation included in the plurality of reservations based on the first plurality of initial assignments.

2. The computer-implemented method of claim 1, further comprising:
retrieving, from the one or more data sources, (i) an additional plurality of reservations associated with a second time frame and (ii) an additional plurality of available rooms associated with the second time frame; and
generating a second plurality of initial assignments of at least a portion of the additional plurality of available rooms to the additional plurality of reservations, wherein the second plurality of initial assignments includes a reassignment of a room included in the at least a portion of the plurality of available rooms to a second reservation included in the additional plurality of reservations.

3. The computer-implemented method of claim 2, wherein the second plurality of initial assignments is generated based on a time interval between a current time and at least one time included in the second time frame.

4. The computer-implemented method of claim 1, further comprising:
generating, for the first reservation, a ranking of a corresponding set of valid assignments based on a set of ranking criteria,
wherein performing the check-in process for the first reservation is further based on the ranking.

5. The computer-implemented method of claim 4, wherein performing the check-in process for the first reservation further based on the ranking comprises assigning, to the first reservation, a highest-ranked room that is (i) included in the ranking and (ii) ready for check-in.

6. The computer-implemented method of claim 4, wherein generating the ranking comprises:
populating a top of the ranking with a first room from an initial assignment that is (i) included in the first plurality of initial assignments and (ii) associated with the first reservation; and
adding a set of additional rooms from the set of valid assignments for the first reservation to a set of positions below the top of the ranking based on a plurality of factors associated with the set of additional rooms.

7. The computer-implemented method of claim 6, wherein the plurality of factors comprises at least one of a guest request, an equivalent reservation, a current availability, a future availability, a room scarcity, a travel-with assignment, or a room utilization.

8. The computer-implemented method of claim 1, wherein generating the first plurality of initial assignments comprises:
for each reservation included in the plurality of reservations, computing a set of scores between the reservation and a corresponding set of valid assignments based on the plurality of matching objectives; and
determining the first plurality of initial assignments via an optimization associated with the sets of scores for the plurality of reservations.

9. The computer-implemented method of claim 8, wherein computing the set of scores comprises computing a first portion of a score included in the set of scores based on a first subset of the plurality of matching objectives associated with the reservation.

10. The computer-implemented method of claim 9, wherein computing the set of scores further comprises computing a second portion of the score based on a second subset of the plurality of matching objectives associated with a travel-with party for the reservation.

11. The computer-implemented method of claim 10, wherein the second subset of the plurality of matching objectives comprises at least one of a proximity between members of the travel-with party or a separation between members of the travel-with party.

12. The computer-implemented method of claim 9, wherein the first subset of the plurality of matching objectives comprises at least one of an assignment of a room to the reservation, a preservation of an existing room assignment for the reservation, a fit between a first room type of the reservation and a second room type for the room, or a fulfillment of a guest request associated with the reservation.

13. One or more non-transitory computer-readable media storing instructions that, when executed by one or more processors, cause the one or more processors to perform the steps of:
retrieving, from one or more data sources, (i) a plurality of reservations associated with a first time frame and (ii) a plurality of available rooms associated with the first time frame;
for each reservation included in the plurality of reservations, generating a set of valid assignments of one or more rooms included in the plurality of available rooms;
generating, based on (i) the sets of valid assignments for the plurality of reservations and (ii) a plurality of matching objectives, a first plurality of initial assignments of at least a portion of the plurality of available rooms to the plurality of reservations; and
performing a check-in process for a first reservation included in the plurality of reservations based on the first plurality of initial assignments.

14. The one or more non-transitory computer-readable media of claim 13, wherein the instructions further cause the one or more processors to perform the steps of:
after the first plurality of initial assignments is generated, retrieving, from the one or more data sources, (i) an updated plurality of reservations associated with the first time frame and (ii) an updated plurality of available rooms associated with the first time frame; and
generating a second plurality of initial assignments of at least a portion of the updated plurality of available rooms to at least a portion of the updated plurality of reservations, wherein the second plurality of initial assignments includes a reassignment of a room included in the at least a portion of the plurality of available rooms to a second reservation included in the updated plurality of reservations.

15. The one or more non-transitory computer-readable media of claim 14, wherein the updated plurality of reservations and the updated plurality of available rooms are retrieved based on at least one of a level of demand associated with the first time frame, an elapsed time since the first plurality of initial assignments was generated, or an availability of the updated plurality of reservations or the updated plurality of available rooms.

16. The one or more non-transitory computer-readable media of claim 13, wherein generating the set of valid assignments comprises matching at least one of a room type, a group size, or a time period associated with the reservation to the one or more rooms.

17. The one or more non-transitory computer-readable media of claim 13, wherein generating the first plurality of initial assignments comprises:
training a machine learning model that comprises a plurality of weights associated with the plurality of matching objectives based on a set of previous assignments and a set of outcomes associated with the set of previous assignments; and
generating, via execution of the trained machine learning model, the first plurality of initial assignments.

18. The one or more non-transitory computer-readable media of claim 13, wherein performing the check-in process comprises automatically executing the check-in process upon detecting, via a mobile device of a user associated with the first reservation, a proximity of the user to a property associated with the plurality of available rooms.

19. The one or more non-transitory computer-readable media of claim 13, wherein the first plurality of initial assignments is generated using a mixed integer programming technique.

20. A system, comprising:
one or more memories that store instructions, and
one or more processors that are coupled to the one or more memories and, when executing the instructions, are configured to perform the steps of:
retrieving, from one or more data sources, (i) a plurality of reservations associated with a first time frame and (ii) a plurality of available rooms associated with the first time frame;
for each reservation included in the plurality of reservations, generating a set of valid assignments of one or more rooms included in the plurality of available rooms based on (i) a first set of attributes associated with the reservation and (ii) a second set of attributes associated with the plurality of available rooms;
generating, based on (i) the sets of valid assignments for the plurality of reservations and (ii) a plurality of matching objectives, a first plurality of initial assignments of at least a portion of the plurality of available rooms to the plurality of reservations; and
performing a check-in process for a first reservation included in the plurality of reservations based on the first plurality of initial assignments.
